(19) United States
(12) Patent Application Publication
(10) Pub. No.: US 2012/0019883 A1
(43) Pub. Date: Jan. 26, 2012

(54) HOLOGRAPHIC DISPLAYS WITH HIGH RESOLUTION

(75) Inventors: Byung Gyu CHAE, Daejeon (KR); Seong Su Park, Daejeon (KR); Seung Ho Ahn, Daejeon (KR)

(73) Assignee: Electronics and Telecommunications Research Institute, Daejeon (KR)

(21) Appl. No.: 13/190,415

(22) Filed: Jul. 25, 2011

(30) Foreign Application Priority Data
Jul. 26, 2010 (KR) 10-2010-0072066
Dec. 8, 2010 (KR) 10-2010-0125081

(51) Int. Cl. G03H 1/12

(52) U.S. Cl. 359/11

(57) ABSTRACT

Provided is a holographic display that realizes a high-resolution three-dimensional (3D) image as a spatial light modulation panel system having a fast response time and enabling the formation of high-density pixels is developed. The holographic display includes, a spatial light modulator using a polymer thin film or a dielectric thin film that enable the formation of high-density pixels and has a fast response time, a fine displacement panel system sequentially moving the spatial light modulator in synchronization with a hologram fringe signal, and an optical system including a coherent light source, a spatial light modulation panel system, and an optical element that are efficiently disposed. The holographic display has a feature that realizes a high-resolution 3D image in a scheme that integrates and displays an image while sequentially moving a spatial light modulator simply or overlaps a hologram fringe pattern.

### CROSS-REFERENCE TO RELATED APPLICATIONS

This U.S. non-provisional patent application claims priority under 35 U.S.C. §119 of Korean Patent Application Nos. 10-2010-0072066, filed on Jul. 26, 2010, and 10-2010-0125081, filed on Dec. 8, 2010, the entire contents of which are hereby incorporated by reference.

### BACKGROUND OF THE INVENTION

The present invention disclosed herein relates to a holographic display, and more particularly, to a spatial light modulation panel system which enables the formation of high-density pixels and has a fast response time, and to a holographic display which integrates and displays an image by sequentially moving a spatial light modulator or displays a high-resolution three-dimensional (3D) image in a scheme of overlapping a hologram fringe pattern.

A 3D holographic technology fundamentally prevents eye fatigue that is caused by a 3D scheme of allowing a 3D image to be viewed with binocular disparity, and is drawing much attention as a next generation 3D image technology that is ultimately required. In a holographic image, a user directly views the forming of an actual image with eyes unlike in the existing scheme that allows a user to feel dimensionality through an optical illusion, and thus, the user feels dimensionality as in the viewing of a real object. Therefore, even when a user views a holographic image for a long time, the user does not feel fatigue.

Dr. Gabor discovered the holography technology while researching a method that records the wave front of an electron beam and enhances a resolving power of an electron microscope, in 1949. Afterward, technology has been advanced highly, and thus, a photograph technology that records a hologram in a film and reproduces the recorded hologram by using a light has been advanced by the degree where a natural color image may be realized in high resolution. In technology that electronically displays a moving image, however, in order to obtain and process massive hologram data, high-density electronic devices are required to be developed, and a data processing speed and a data transmission speed are required to be advanced far higher than the current technology. That is, the technology that electronically displays a moving image is in an initial stage.

The Two-Dimensional (2D) photograph technology records only the intensity of a light and reproduces an image, but the holography is technology that records the intensity and phase of a light together and reproduces a Three-Dimensional (3D) image. The holography records an interference fringe between a reference wave and an object wave, reflected by an object, in a photosensitive film in a hologram type by using a coherent light source. That is, the existing 2D photograph technology directly records an image in a film, but the holography does not record an image but records an interference fringe in a photosensitive film. Herein, when irradiating a reference wave on a hologram photosensitive film, the phase of an object is reproduced in the original location as-is according to the light diffraction principle. Above all, a photosensitive film is required to have a high resolving power so as to see a high-resolution image within broad view. To date, many hologram photosensitive films for realizing high resolution have been developed.

However, technology of manufacturing an electronic device that electronically acquires and displays a hologram is largely insufficient to obtain a high-resolution image. That is, a capture device or a display having several to tens of billions (G) or more of pixels is required for displaying all the amount of hologram information. The amount of information included in a hologram is simply calculated by computing the number of interference fringes with the Bragg diffraction equation “2d·sinθ/λ”. Herein, d indicates a hologram size, λ indicates a wavelength of a light, and θ indicates an angle between a reference wave and an object wave when recording a hologram. For example, even when it is assumed that a 10 cm×10 cm hologram is recorded at an angle of 30 degrees by using the He—Ne laser (λ=0.6328 μm), the total amount of information is about 25 gigabyte (GB). Therefore, when a high-density hologram display device having a pixel size of 0.6 μm or less has been developed, a high-resolution 3D image can be displayed.

Recently, the digital holography technology has been advanced highly, and thus, technology of acquiring an image to generate a hologram is approaching a realizable level. Technology, which uses a camera for obtaining depth information or captures an image in an integral imaging method to generate a hologram, is being developed, and particularly, an operational algorithm that considerably reduces the amount of hologram information by decreasing vertical parallax has been developed. Therefore, there is very high possibility that the technology of acquiring an image to generate a hologram will be realized due to the current advance of a data processing speed and data transmission speed.

A method of displaying a hologram uses an Acousto-Optic Modulator (AOM) or a Spatial Light Modulator (SLM) such as a Liquid Crystal Display (LCD). The Massachusetts Institute of Technology (MIT) space imaging group and Korea Institute of Science and Technology (KIST) have manufactured the multi-channel AOM to display a 3D image. However, since AOMs fundamentally display a linear hologram, the AOMs have a limitation in that the AOMs show only horizontal parallax. Also, since AOMs have a mechanical scheme that uses a vertical mirror, a polygon mirror, etc., the AOMs have a relatively complicated structure. Chiba University in Japan, etc., is making an effort to realize a moving image of a natural color with an SLM such as an LCD. However, since LCD devices have limitations in that it is difficult to realize a fast response time and a high density, current technology cannot fundamentally realize a high-resolution 3D image.

### SUMMARY OF THE INVENTION

The present invention provides a holographic display, which realizes a high-resolution three-dimensional (3D) image by using a spatial light modulator, manufactured with a dielectric thin film or a polymer thin film having a fast response time, in order to solve difficulties (which occur in the existing acousto-optic modulator or spatial light modulator such as an LCD) in realizing high-density pixels.

The present invention also provides a spatial light modulation panel system which displays a hologram while sequentially moving a spatial light modulator having a fast response time, thereby displaying a high-resolution 3D image.

In embodiments of the present invention, a holographic display includes; a spatial light modulator using a polymer thin film or a dielectric thin film that enable the formation of high-density pixels and has a fast response time; a fine displacement panel system sequentially moving the spatial light modulator in synchronization with a hologram fringe signal; and an optical system including a coherent light source, a spatial light modulation panel system, and an optical element.

The polymer thin film and the dielectric thin film have a very large electro-optic coefficient and have a fast response time when an electric field is applied, and thus have features suitable for being applied to the spatial light modulator.

The spatial light modulator having a fast response time is formed by stacking a vertical polarizer and a horizontal polarizer at respective both surfaces of a panel that is formed with the polymer thin film or the dielectric thin film.

The spatial light modulator controls the polarization of an incident light to modulate a light by using the electro-optic effect of the polymer thin film or dielectric thin film.

A method of forming the spatial light modulation layer includes: a process that deposits the polymer thin film or the dielectric thin film on a transparent substrate or a lower transparent electrode/the transparent substrate; a process that performs patterning for each pixel; an operation that forms a metal electrode; and an operation that forms a thin film transistor in each pixel.

The spatial light modulator having a fast response time changes a phase of a light to control the modulation of a light without using a polarizer.

The fine displacement panel system provides a device that displays a hologram fringe pattern while sequentially moving the spatial light modulator in synchronization with a hologram fringe signal.

In such scheme, when it is assumed that a 3D image before division is one frame 3D image, a sequentially-reproduced 3D image is integrated in one frame before division, thereby realizing a high-resolution 3D image.

In the above-described scheme, another scheme duplicates and records a hologram, which is displayed on an Electrically Addressed Spatial Light Modulator (EASLM) that sequentially moves and records a hologram as an electric field, in an Optically Addressed Spatial Light Modulator (OASLM) that records a hologram as a light to generate a high-density hologram, thereby realizing a 3D image.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1A is a schematic diagram illustrating a holographic display device for displaying a 3D image, according to an embodiment of the present invention;

FIG. 1B is a schematic diagram illustrating a holographic display device using a reflective spatial light modulator, according to an embodiment of the present invention;

FIG. 2A is a block diagram illustrating a spatial light modulator using a dielectric thin film or polymer thin film which shows an electro-optic effect;

FIG. 2B is a structure diagram for describing the principle on a pockels effect;

FIG. 2C is a diagram showing the change of a light transmittance based on an applied voltage;

FIG. 3A is a structure diagram illustrating a reflective spatial light modulator using a polymer thin film or a dielectric thin film;

FIG. 3B is a structure diagram illustrating a spatial light modulator with transistors which are separated and integrated by a Complementary Metal-Oxide Semiconductor (CMOS) technology;

FIG. 4A is a plan view illustrating an array structure of a spatial light modulation panel layer;

FIG. 4B is a sectional view illustrating a light modulation layer of each pixel in the spatial light modulation panel layer;

FIG. 5A is a plan view illustrating an array structure of a spatial light modulation panel layer having a structure which differs from the structure of FIG. 4A;

FIG. 5B is a sectional view illustrating a light modulation layer of each pixel in a spatial light modulation panel layer;

FIG. 6 is a sectional view of a spatial light modulation panel layer using the Mach-Zehnder interference principle which controls the modulation of a light without using a polarization principle, in a spatial light modulator using a polymer thin film or dielectric thin film;

FIG. 7 is a diagram illustrating a fine displacement spatial light modulation panel system which displays a hologram fringe pattern while sequentially moving a spatial light modulator;

FIG. 8 is a diagram showing a principle which realizes a high-resolution 3D image by integrating an image according to an embodiment of the present invention; and

FIG. 9 is a diagram illustrating a scheme which realizes a high-resolution 3D image by overlapping a hologram fringe pattern according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

The present invention may, however, be embodied in many different forms and should not be construed as being limited to the embodiments set forth herein; rather, these embodiments are provided so that those skilled in the art thoroughly understand this present invention. Rather, these embodiments are provided so that this disclosure will be thorough and complete, and will fully convey the scope of the present invention to those skilled in the art. Also, in the figures, the dimensions of layers and regions are exaggerated for clarity of illustration.

In the following description, the technical terms are used only for explaining a specific exemplary embodiment while not limiting the present invention. The terms of a singular form may include plural forms unless referred to the contrary. The meaning of ‘comprises’ and/or ‘comprising’ specifies a property, a region, a fixed number, a step, a process, an element and/or a component but does not exclude other properties, regions, fixed numbers, steps, processes, elements and/or components.

Additionally, the embodiment in the detailed description will be described with sectional views as ideal exemplary views of the present invention. Accordingly, shapes of the exemplary views may be modified according to manufacturing techniques and/or allowable errors. Therefore, the embodiments of the present invention are not limited to the specific shape illustrated in the exemplary views, but may include other shapes that may be created according to manufacturing processes.

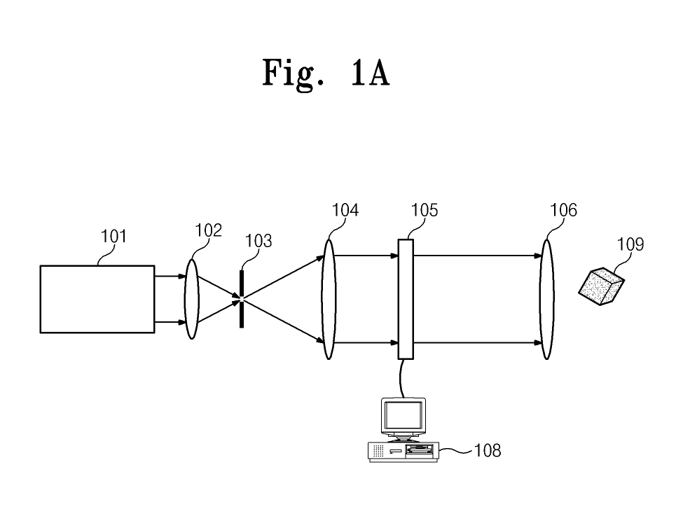

FIG. 1A is a schematic diagram illustrating a holographic display device for displaying a 3D image, according to an embodiment of the present invention.

Referring to FIG. 1A, the holographic display device according to an embodiment of the present invention includes a lighting part that changes a light to a coherent flat light, a spatial light modulation panel system displaying a hologram fringe pattern, and an optical part reproducing a 3D image.

The lighting part includes a laser or Light Emitting Diode (LED) light source 101 emitting a coherent light, an object lens 102 changing a light to a flat light, a spatial filter using a pin hole 103, and a collimating lens 104. Such elements may be appropriately disposed to be separated from each other according to the diameter of a desired flat beam.

The spatial light modulation panel system displaying the hologram fringe pattern is designed and manufactured to display the hologram fringe pattern while sequentially moving a spatial light modulator 105. A computer 108 such as a Personal Computer (PC) may control the spatial light modulator 105 that displays a hologram fringe pattern while sequentially moving.

By optimizing an optical system, the optical part 106 reproducing a 3D image is designed to a reproduced image 109 with high efficiency.

FIG. 1B is a schematic diagram illustrating a holographic display device using a reflective spatial light modulator, according to an embodiment of the present invention.

Referring to FIG. 1B, the a holographic display device using the reflective spatial light modulator includes a lighting part that changes a light to a coherent flat light, a beam splitter 107, a spatial light modulation panel system displaying a hologram fringe pattern, and an optical part 106 reproducing a 3D image.

The beam splitter 107 transfers an incident beam to the spatial light modulator 105, and transfers a beam, reflected by the spatial light modulator 105, to the optical part 106.

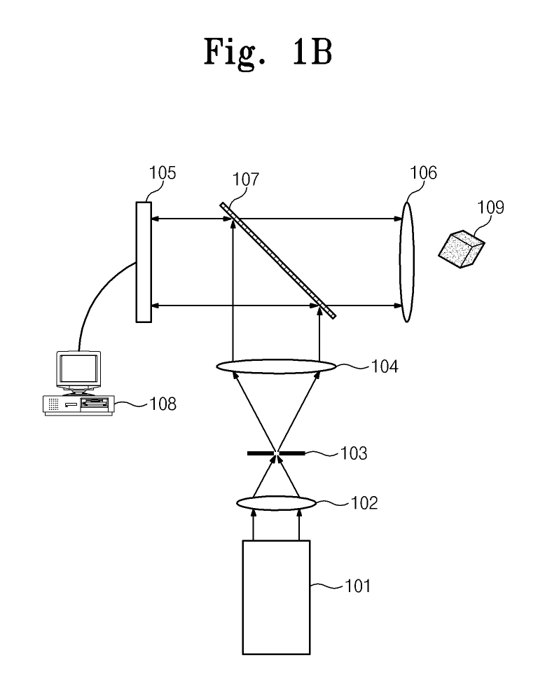

FIG. 2A is a block diagram illustrating a spatial light modulator using a dielectric thin film or polymer thin film which shows an electro-optic effect.

Referring to FIG. 2A, two linear polarizers are disposed to perpendicularly intersect in polarization direction, at respective both surfaces of the spatial light modulation panel layer 201 where a plurality of pixels are integrated at a high density. That is, the two linear polarizers are stacked substantially. Herein, a compensator 203 is appropriately disposed for optimizing a light modulation efficiency.

FIG. 2B is a structure diagram for describing the principle on a pockels effect.

As illustrated in FIG. 2B, when applying an electric field to an electro-optic material 204, a refractive index is changed by the electro-optic effect, and a phase is shifted. At this point, an incident light, which is lineally polarized by passing through a linear polarizer 205, is ovally polarized (see 206 in FIG. 2B) and travels due to anisotropy of a thin film. A phase in a thin film is shifted according to Equation (1) below.

Δφ=CγlV (1)

where C indicates a specific constant, l indicates a light traveling distance, and V indicates an external voltage.

Particularly, when an electro-optic coefficient (γ) is large, a phase may be easily shifted, and all incident light is transmitted by changing linear polarization by 90 degrees in half-wavelength phase shift. Such a light passes through a linear polarizer 207, and thus, a light modulation is completed.

FIG. 2C is a diagram showing the change of a light transmittance based on an applied voltage. The light transmittance is calculated based on a polarization direction and the disposition of polarizers. It can be seen that the light transmittance is effectively controlled by using the principle.

In order to efficiently perform oval polarization by using anisotropy of a light modulation thin film, the polarization direction of a linear polarizer in a light incident part may be disposed to be inclined by 45 degrees with respect to a light axis.

The spatial light modulator controls a light transmittance by applying an electric signal to each pixel. However, when there is no electric signal, namely, when in an off state, since a polymer thin film or a dielectric thin film has optical isotropy, a light that has been linearly polarized through one linear polarizer cannot pass through another vertically-polarized polarizer, and thus, a light is not transmitted. In this case, when an electric signal is applied, namely, when in an on state, a refractive index is changed by the electro-optic effect, and thus, a linearly-polarized light is ovally polarized while passing through a thin film to pass through another linear polarizer.

As described above, the spatial light modulator effectively controls an on/off state on the transmission of a light by applying an electric signal to each pixel, and moreover, controls a light transmittance intensity by dividing electric signal intensity. Accordingly, the system becomes a spatial light modulator that modulates an intensity and a phase of a light.

The spatial light modulator efficiently controls each pixel by using a multi-cell signal processing technology.

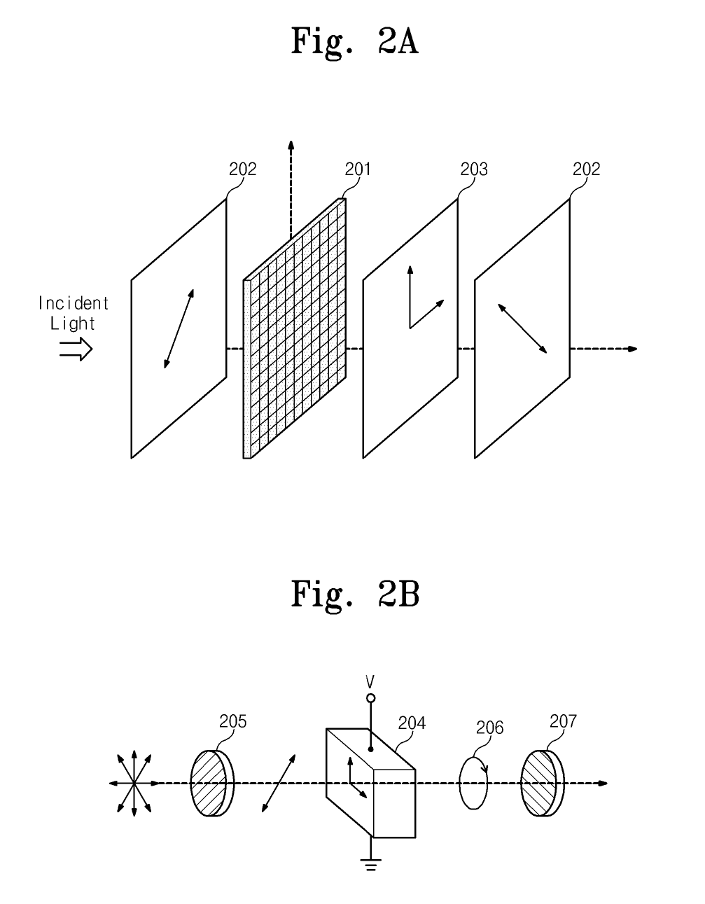

FIG. 3A is a structure diagram illustrating a reflective spatial light modulator using a polymer thin film or a dielectric thin film.

Referring to FIG. 3A, the reflective spatial light modulator includes the reflective spatial light modulator includes a spatial light modulation panel layer 201 having a plurality of pixels integrated at a high density, a linear polarizer 202, a compensator 203, and a light reflective panel 301.

FIG. 3B is a structure diagram illustrating a spatial light modulator with transistors which are separated and integrated by a Complementary Metal-Oxide Semiconductor (CMOS) technology.

Referring to FIG. 3B, the spatial light modulator includes a transistors-integrated part 302, a light reflective pattern 303, and a spatial light modulation panel layer 304 that are stacked. As illustrated in FIG. 3B, an incident light and a reflected light are controlled by two polarizers 305 that are appropriately disposed in an upper portion and intersect perpendicularly.

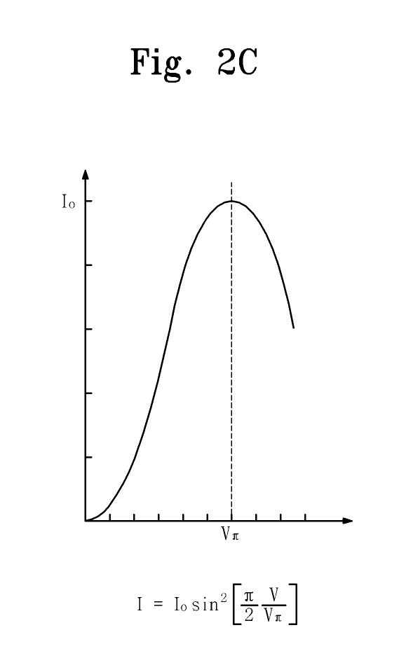

FIG. 4A is a plan view illustrating an array structure of the spatial light modulation panel layer. For convenience, FIG. 4A illustrates the disposition of some pixels, and thus enables the understanding of an entire structure of the spatial light modulation panel layer.

A unit pixel in the spatial light modulation panel layer includes a light modulation layer 401 formed with a polymer thin film or a dielectric thin film, metal lines 402 for addressing each pixel, and a thin film transistor 403.

As illustrated in FIG. 4A, the pixels are efficiently disposed spaced apart from each other in order to prevent interference therebetween. Each pixel is connected to the vertical metal line 402 and the horizontal metal line 402 so as to enable independent access, and is controlled by the thin film transistor 403.

In FIG. 4A, the disposition of respective elements is a specific example and is not limited thereto. A transparent transistor and a light modulation panel layer may be manufactured to be stacked.

FIG. 4B is a sectional view illustrating a light modulation layer of each pixel in the spatial light modulation panel layer.

A method of forming the light modulation layer includes: a process that deposits a lower transparent electrode 405 on a transparent substrate 404; a process that deposits a polymer thin film 406 or a dielectric thin film 406 on the lower transparent electrode 405; an operation that forms an upper transparent electrode 407 on the polymer thin film 406 or dielectric thin film 406; and a process that performs patterning for each unit pixel.

The transparent electrode 405 may include an oxide electrode such as ITO, SnO₂, and ZnO₂. The transparent electrode 405 may be formed on the amorphous or isotropic crystal transparent substrate 404 in a thin film deposition process such as an electron beam deposition process or a sputter process.

The polymer thin film 406 or the dielectric thin film 406 has a very large electro-optic coefficient of about tens pm/V and a high switching speed of nanosecond or less, and thus can efficiently modulate a light with an electric field.

The polymer thin film 306 includes at least one of polymer materials, which show very large optical anisotropy when an electric field is applied, such as PMMA, P2ANS, DANS/MMA, NPT/epoxy, and PUR/AZO.

The dielectric thin film 306 includes dielectric such as LiNbO₃, LiTaO₃, NH₄H₂PO₄, KH₂PO₄, perobarskite-based material such as BaTiO₃, and PLZT-based material with very large electro-optic effect.

In the embodiment of the present invention, a material used in the spatial light modulator is not limited to polymer or dielectric, and may include various materials with large electro-optic coefficient. Herein, the material may include semiconductor materials such as GaAs, InP, and CdS.

The polymer thin film 406 and the dielectric thin film 406 may be formed by a chemical deposition process such as a sol-gel process or a Chemical Vapor Deposition (CVD) process, or a physical deposition process such as a sputter process.

The spatial light modulator with the polymer thin film 406 or dielectric thin film 406 enables high-speed switching and the integrating of pixels at a high density compared to the existing LCD devices, in characteristic.

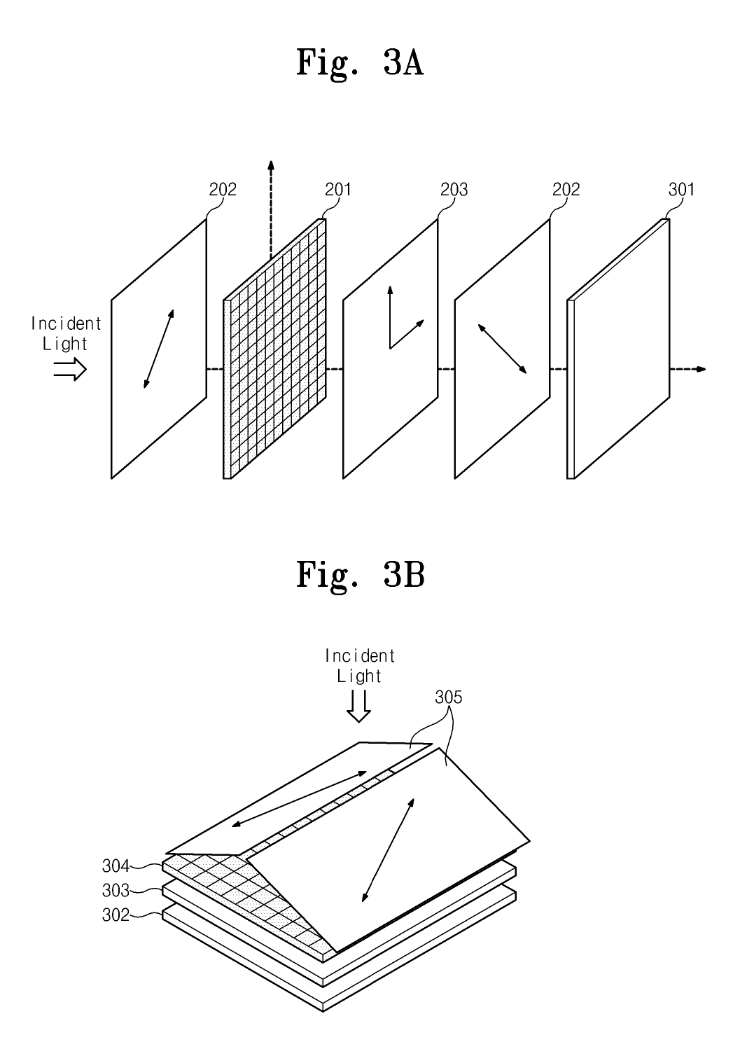

FIG. 5A is a plan view illustrating an array structure of a spatial light modulation panel layer having a structure which differs from the structure of FIG. 4A. The spatial light modulation panel layer of FIG. 5A may be formed by directly depositing a polymer thin film or a dielectric thin film on a transparent substrate.

A unit pixel in the spatial light modulation panel layer includes a polymer thin film 501 or dielectric thin film 501, metal lines 502 and a metal electrode 503 for addressing each pixel, and a thin film transistor 403.

As illustrated in FIG. 5A, the pixels are efficiently disposed spaced apart from each other in order to prevent interference therebetween. Each pixel is connected to a vertical metal line and a horizontal metal line so as to enable independent access, and is controlled by a thin film transistor.

FIG. 5B illustrates a sectional view and driving principle of a light modulation layer of each pixel in the spatial light modulation panel layer.

In the spatial light modulator, on/off on the transmission of a light is determined by a voltage that is applied between two electrodes, and it can be seen that an on state of the transmission of a light indicates a case where only one voltage is applied.

That is, when a voltage difference occurs between two electrodes and thus an electric field is applied, as illustrated in FIG. 5B, a refractive index is changed by the electro-optic effect, and thus, a linearly-polarized light is ovally polarized by passing through a thin film, thereby controlling a light transmittance.

A method of forming the light modulation layer includes: a process that deposits a polymer thin film 506 or a dielectric thin film 506 on a transparent electrode 505; an operation that forms a plurality of upper transparent electrodes 507 on the polymer thin film 506 or dielectric thin film 506; and a process that performs patterning for each unit pixel.

Each of the upper transparent electrodes 507 may include an oxide electrode such as ITO, SnO₂, and ZnO₂. The transparent substrate 505 includes an amorphous or isotropic crystal transparent substrate.

The upper transparent electrodes 507 may be formed by a thin film deposition process such as an electron beam deposition process or a sputter process. The polymer thin film 506 and the dielectric thin film 506 may be formed by a chemical deposition process such as a sol-gel process or a CVD process, or a physical deposition process such as a sputter process.

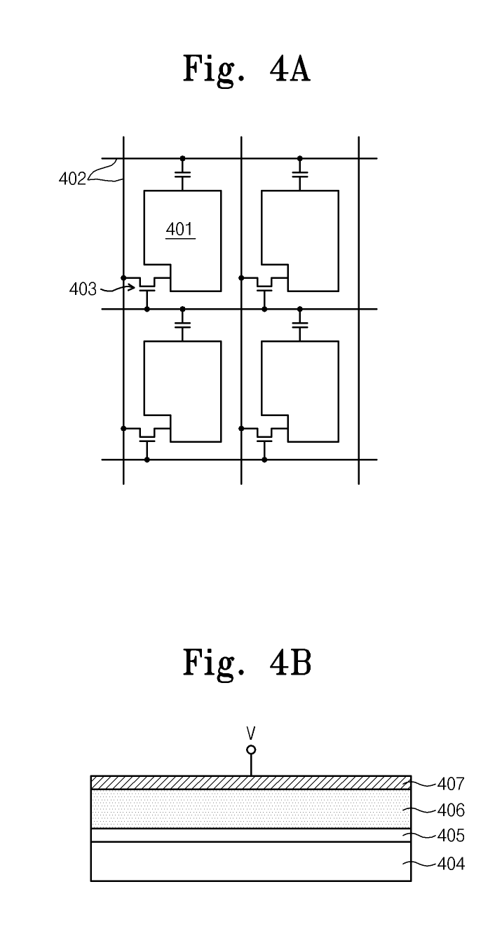

FIG. 6 is a sectional view of a spatial light modulation panel layer using the Mach-Zehnder interference principle which controls the modulation of a light without using a polarization principle, in a spatial light modulator using a polymer thin film or dielectric thin film. As illustrated in FIG. 6, an incident light simultaneously passes through a layer having the electro-optic effect and a layer having no electro-optic effect and then is combined, in which case the modulation of a light is controlled according to a phase difference between beams passing through the two layers.

The spatial light modulator is formed with no vertical and horizontal polarizers. A method of manufacturing the spatial light modulator includes: a process that deposits a polymer thin film 603 or a dielectric thin film 603 on a transparent substrate 601 or a lower transparent electrode 602/the transparent substrate 601; a process that performs patterning for each pixel; an operation that forms an upper transparent electrode 604; and an operation that forms a thin film transistor in each pixel. The lower transparent electrode 602, polymer thin film/dielectric thin film 603 and upper transparent electrode 604 form a region having the electro-optic effect. The lower transparent electrode 602, polymer thin film/dielectric thin film 603, upper transparent electrode 604, and a polymer thin film/dielectric thin film 603 isolated by a light blocking layer 606 form a region having no electro-optic effect. Also, a light reflective layer 605 is used for efficiently combining lights that have passed through two layers.

It is apparent to those skilled in the art that the spatial light modulator with no polarization principle is not limited to the Mach-Zehnder interference principle. That is, various schemes for controlling the phase and intensity of a light may be used in forming the spatial light modulator.

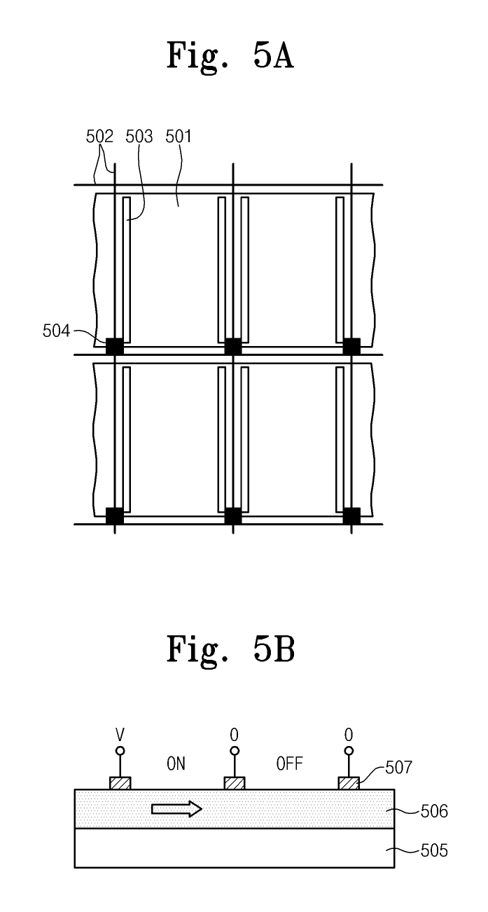

FIG. 7 is a diagram illustrating a fine displacement spatial light modulation panel system which displays a hologram fringe pattern while sequentially moving a spatial light modulator 701.

As shown in FIG. 7, the spatial light modulator 701 may sequentially move in a diagonal direction in synchronization with a hologram fringe signal. The fine displacement of the spatial light modulator 701 may be implemented with a piezoelectric element. Such scheme is a scheme that performs moving through several-times to tens-times equal divisions in regard to one pixel.

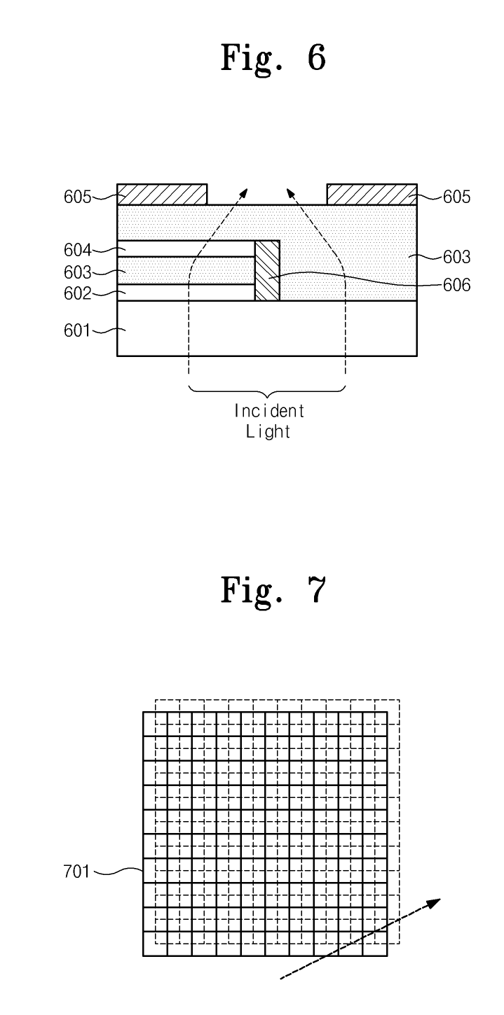

FIG. 8 is a diagram showing a principle which realizes a high-resolution 3D image by integrating an image according to an embodiment of the present invention.

As shown in FIG. 8, for example, when a pixel size is about 10 gm×10 μm, a 3D image is blurredly shown because it is very insufficient to display a hologram interference pattern. However, according to the embodiment of the present invention, when the hologram fringe pattern is displayed by dividing the pixel size into ten equal parts, a pixel size 801 of 1 μm×1 μm may obtain the effect such as displaying the hologram fringe pattern.

A principle of realizing the high-resolution 3D image will be described below.

In realizing the high-resolution 3D image, a first operation and a second operation are sequentially repeated in a divided region. Herein, the first operation displays a hologram interference pattern on a spatial light modulator and simultaneously irradiates a reproduced light on the spatial light modulator to reproduce a 3D image. The second operation moves the spatial light modulator by one stage and then displays a hologram fringe pattern, generated suitably for the moved spatial light modulator, to reproduce a 3D image. In this case, when it is assumed that a 3D image before division is one frame 3D image, a sequentially-reproduced 3D image is integrated in one frame before division, thereby realizing a high-resolution 3D image.

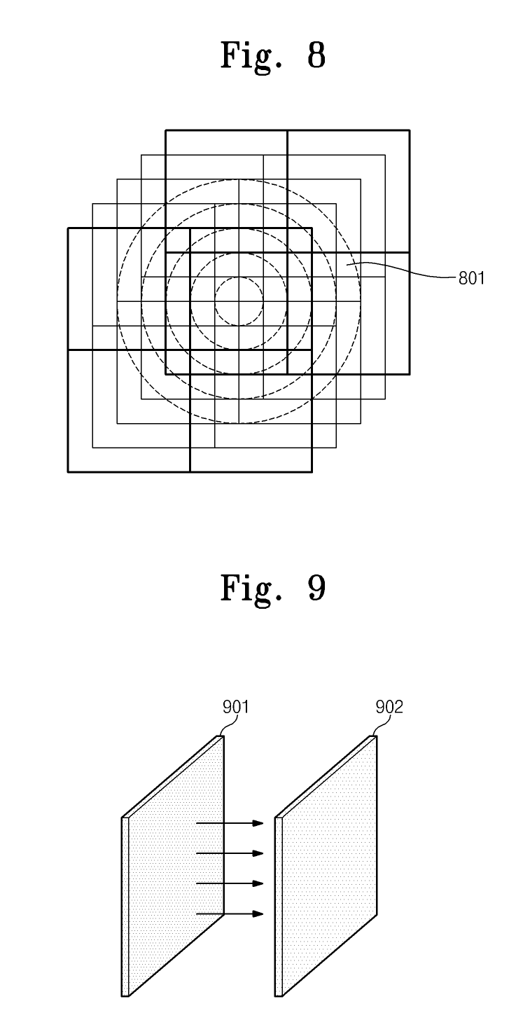

FIG. 9 is a diagram illustrating a scheme which realizes a high-resolution 3D image by overlapping a hologram fringe pattern in a scheme different from the above-described scheme.

A principle of realizing the high-resolution 3D image will be described below.

As illustrated in FIG. 9, the principle does directly not regenerate a hologram fringe pattern, displayed on a spatial light modulator (EASLM) 901 that records a hologram as an electric field, as a reproduced light but duplicates a hologram fringe pattern to a spatial light modulator (OASLM) 902 that records a hologram as a light by using a radiant light. Herein, the principle overlaps and records a hologram fringe pattern in the spatial light modulator 902 while sequentially moving the spatial light modulator 901 to generate a high-density hologram. In this case, the hologram fringe pattern sequentially displayed on the spatial light modulator 901 is appropriately calculated and generated in order to generate an initial high-density hologram in a scheme that overlaps and records a hologram fringe pattern in the spatial light modulator 902. Finally, the principle irradiates a reproduced light on a high-density hologram fringe pattern recorded in the spatial light modulator 902, thereby realizing a 3D image.

As described above, the holographic display device according to the embodiments of the present invention, which integrates an image with the spatial light modulator having a fast response time and provides a high-resolution 3D image, solves difficulties in realizing the high-resolution 3D image and reproduces a vivid 3D image.

In the high-resolution holographic display according to the embodiments of the present invention, moreover, as the spatial light modulator using the polymer thin film or the dielectric thin film is developed, the high-density spatial light modulator having a fast response time can be realized.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A holographic display device comprising:
a lighting part generating a coherent flat beam;
a spatial light modulation panel system comprising a spatial light modulator which modulates light with an electro-optic effect; and
an optical part reproducing a three-dimensional (3D) image.

2. The holographic display device of claim 1, wherein the lighting part comprises:
a light source emitting a coherent light; and
an object lens, a spatial filter and a collimating lens disposed in series, changing the coherent light to the coherent flat beam,
wherein,
the spatial filter uses a pin hole, and
separated distances between the light source, the object lens, the spatial filter and the collimating lens are controlled according to a diameter of a desired flat beam.

3. The holographic display device of claim 1, wherein the spatial light modulator has a transmissive structure or a reflective structure.

4. The holographic display device of claim 3, wherein the reflective structure further comprises a beam splitter disposed between the spatial light modulator and the lighting part.

5. The holographic display device of claim 1, wherein the spatial light modulation panel system displays a hologram fringe pattern while sequentially moving the spatial light modulator.

6. The holographic display device of claim 5, wherein the spatial light modulation panel system sequentially moves the spatial light modulator in a diagonal direction in synchronization with a hologram fringe signal, the movement of the spatial light modulator being realized with a piezoelectric element.

7. The holographic display device of claim 6, wherein the spatial light modulator is spatially divided and driven for efficient movement.

8. The holographic display device of claim 6, wherein a principle of reproducing the 3D image comprises:
displaying a hologram interference pattern on the spatial light modulator and simultaneously irradiating a reproduced light on the spatial light modulator to reproduce the 3D image; and
sequentially repeating an operation of moving the spatial light modulator by one stage and then displaying the hologram fringe pattern, generated suitably for the moved spatial light modulator, to reproduce the 3D image, in a divided region,
the sequentially-reproduced 3D image is integrated and reproduced in one frame before the 3D image is divided into a plurality of regions.

9. The holographic display device of claim 6, wherein a principle of reproducing the 3D image comprises:
duplicating the hologram fringe pattern to a first spatial light modulator (OASLM) which records a hologram as a light by using a radiant light without directly regenerating the hologram fringe pattern, displayed on a second spatial light modulator (EASLM) which records a hologram as an electric field, as a reproduced light;
generating a high-density hologram in a scheme which overlaps and records the hologram fringe pattern in the first spatial light modulator while sequentially moving the second spatial light modulator, and then irradiating the reproduced light to reproduce the 3D image.

10. The holographic display device of claim 1, wherein the spatial light modulator further comprises:
a spatial light modulation panel layer comprising integrated pixels; and
first and second linear polarizers respectively disposed at both surfaces of the spatial light modulation panel layer, and perpendicularly intersecting in a polarization direction.

11. The holographic display device of claim 10, wherein the spatial light modulator controls an on or off state on transmission of a light by applying an electric signal to a plurality of pixels, and divides an intensity of the electric signal to control an intensity of a light transmittance.

12. The holographic display device of claim 10, wherein at least one of the first and second linear polarizers is separated from the spatial light modulation panel layer to control the light transmittance.

13. The holographic display device of claim 10, wherein the spatial light modulation panel layer comprises:
a light modulation layer using the electro-optic effect; and
a plurality of transistors and metal lines for addressing a plurality of pixels, respectively.

14. The holographic display device of claim 13, wherein the light modulation layer comprises:
a transparent substrate;
a lower transparent electrode on the transparent substrate;
a light modulation film on the lower transparent electrode; and
an upper transparent electrode on the light modulation film.

15. The holographic display device of claim 14, wherein the light modulation film has an electro-optic coefficient of tens pm/V or more and a high switching speed of microsecond or less.

16. The holographic display device of claim 14, wherein,
the light modulation layer further comprises a light modulation region, which comprises the lower transparent electrode, the light modulation film and the upper transparent electrode, and a non-light modulation region isolated by a light blocking layer, and
the modulation of a light is controlled with a phase difference occurring when the coherent flat beam simultaneously passes through the light modulation region and the non-light modulation region and then is combined.

17. The holographic display device of claim 13, wherein the light modulation layer comprises:
a transparent substrate;
a light modulation film on the transparent substrate; and
a plurality of transparent electrodes on the light modulation film.

18. The holographic display device of claim 13, wherein,
when an electric field is applied to the light modulation layer, a refractive index of the light modulation layer is changed by the electro-optic effect and a phase is shifted,
the coherent flat beam, which has been linearly polarized by the first linear polarizer, is ovally polarized by anisotropy of the light modulation layer, and
the ovally-polarized coherent flat beam is controlled in light modulation by passing through the second linear polarizer.

19. The holographic display device of claim 1, wherein the spatial light modulator further comprises a compensator optimizing a light modulation efficiency.

20. The holographic display device of claim 1, wherein the spatial light modulator changes a phase and an intensity of the light to modulate the light without using a polarization principle.
